(19) United States
(12) Patent Application Publication
(10) Pub. No.: US 2014/0356717 A1
(43) Pub. Date: Dec. 4, 2014

(54) Lithium Ion Secondary Battery Positive Electrode, Lithium Ion Secondary Battery, Vehicle Mounting the Same, and Electric Power Storage System

(71) Applicant: Hitach, Ltd., Chiyoda-ku, Tokyo (JP)

(72) Inventors: Akira Gunji, Tokyo (JP); Shin Takahashi, Tokyo (JP); Hiroaki Konishi, Tokyo (JP); Xiaoliang Feng, Tokyo (JP); Takuya Aoyagi, Tokyo (JP)

(21) Appl. No.: 14/365,909

(22) PCT Filed: Nov. 21, 2012
(86) PCT No.: PCT/JP2012/080118

§ 371 Date: Jun. 16, 2014

(30) Foreign Application Priority Data
Dec. 22, 2011 (JP) 2011-280688

(51) Int. Cl. H01M 4/36; H01M 4/48; H01M 10/0525; H01M 4/52; H01M 4/131; H01M 4/50; H01M 4/505; H01M 4/525

(52) U.S. Cl. CPC H01M 4/366; H01M 4/505; H01M 4/483; H01M 4/525; H01M 4/523; H01M 4/131; H01M 4/502; H01M 10/0525; H01M 2004/028
USPC 429/221; 429/224; 429/231.1; 429/223; 429/231.2; 429/231.3

(57) ABSTRACT

The present invention is directed to a lithium ion secondary battery positive electrode, a lithium ion secondary battery, a vehicle mounting the same, and an electric power storage system, which improve the electron conductivity even inside an active material formed into a secondary particle. The electrode includes a positive electrode active material expressed by xLi₂MO₃-(1-x)LiM′O₂ (where x is 0<x<1, M is at least one type selected from Mn, Ti, and Zr, and M′ is at least one type selected from Ni, Co, Mn, Fe, Ti, Zr, Al, Mg, Cr, and V), the positive electrode active material forming a secondary particle in which a plurality of primary particles without grain boundary are aggregated/bonded, wherein not only the primary particles positioned on a surface of the secondary particle of the positive electrode active material, but also the primary particles positioned inside the secondary particle are coated with an electron conductive oxide having higher electron conductivity than the positive electrode active material.

### TECHNICAL FIELD

The present invention relates to a lithium ion secondary battery positive electrode, a lithium ion secondary battery, a vehicle mounting the same, and an electric power storage system, in which absorption/emission of lithium ions is performed.

### BACKGROUND ART

In recent years, from the viewpoints of prevention of global warming and concern for depletion of fossil fuel, there are expectations for electric automobiles that require less energy for driving and power generation systems using natural energy, such as sunlight and wind power. However, these technologies have the following technical problems, and there is not much progress in spread of the technologies.

Problems of the electric automobiles are low energy density of a driving battery and a short travel distance with one charge. Meanwhile, problems of the power generation systems using natural energy are that there is considerable variation of the amount of power generation and a large-capacity battery is required for leveling of outputs, resulting in high cost. In either technology, an inexpensive secondary battery having high energy density is in great demand.

Since lithium ion secondary batteries have higher energy density per weight than secondary batteries, such as nickel-hydrogen batteries or lead batteries, application to the electric automobiles and the electric power storage systems is expected. However, to respond to the demands for the electric automobiles and the electric power storage systems, higher energy density is required. For the higher energy of a battery, it is necessary to enhance the energy density of a positive electrode and a negative electrode.

As a positive electrode active material of the high energy density, an Li₂MO₃—LiM′O₂ solid solution is expected. Note that M is one or more types of chemical elements selected from Mn, Ti, and Zr, and M′ is one or more types of chemical elements selected from Ni, Co, Mn, Fe, Ti, Zr, Al, Mg, Cr, and V. Hereinafter, the Li₂MO₃—LiM′O₂ solid solution is abbreviated as solid solution positive electrode active material.

The solid solution of electrochemically inert Li₂MO₃ having a layer structure and electrochemically active LiM′O₂ having a layer structure is a high-capacity positive electrode active material that becomes active and may have a large electrical capacity exceeding 200 mAh/g by being charged by a voltage exceeding 4.4 V (with respect to lithium metal, hereinafter, a potential will be described with respect to lithium metal) at initial charge.

PTL 1 discloses an electrode in which the electron conductivity is improved by coating of a cathode active material composition containing an electron conducting agent, a binder, and a cathode active material and formed on a current collector with a vanadium oxide.

PTL 2 discloses a positive electrode material in which a reaction between an electrolyte solution and a positive electrode is suppressed while the electron conductivity is maintained by coating of a part of positive electrode particles with an electron conductive oxide.

PTL 3 discloses a battery, in which dissolution of a metal in a positive electrode constituent material is suppressed by forming of an electron conductive oxide on a surface of the positive electrode constituent material.

### CITATION LIST

### Patent Literature

PTL 1: JP 2009-76446 A
PTL 2: JP 2009-146811 A
PTL 3: JP 62-274556 A

### SUMMARY OF INVENTION

### Technical Problem

The solid solution positive electrode active material has a problem of high electrode resistance because an Li diffusion coefficient and electron conductivity are low. To supplement the low Li diffusion coefficient, the active material particles are formed to have a small particle diameter of 300 nm or less. However, if the active material is made to have a small particle diameter, a large volume of binders is required and tap density is decreased, and thus a ratio of the active material to a unit volume of the electrode is decreased. Further, handling of the active material having a small particle diameter is difficult because the active material is easily dispersed, manufacturing of uniform slurry is difficult, and the like. Therefore, a plurality of active material particles are aggregated and bonded, and particle aggregate of about 1 to 40 μm is formed. By forming of the particle aggregate, the active material can be handled similarly to micron-order particles. Here, the active material particle having a small particle diameter is defined as a primary particle, and the aggregation of the active material particles is defined as a secondary particle.

Li ions can be diffused in an electrolyte solution in a void among the primary particles and can reach surfaces of the primary particles. Therefore, Li ion diffusion resistance can be decreased by a decrease in the particle diameter of the primary particle. However, the electrons are conducted between a reaction field in the primary particles positioned inside the secondary particle and an electron conducting material that is in contact with the surface of the secondary particle. Therefore, it is necessary that the electrons are conducted in the primary particles. The number of points of contact among the primary particles that becomes resistance in the electron conductivity in the primary particles is increased as a decrease in the particle diameter of the primary particle and an increase in the particle diameter of the secondary particle. Therefore, the electrode resistance caused by the electron conductivity is increased due to the decrease in the particle diameter of the primary particle and the increase in the particle diameter of the secondary particle.

In the configuration of PTL 1, while an electrode conductive path between the cathode active material secondary particle and the electron conducting material can be constructed, the electron conductivity inside the active material secondary particle cannot be enhanced. In addition, in thermal treatment necessary for enhancement of the electron conductivity of a vanadium oxide that is a coating member, the temperature can be raised only up to a heat-resistance temperature of the binder or the current collector, and sufficient electron conductivity cannot be obtained.

In PTLs 2 and 3, the surface of the active material is coated with the electron conductive oxide such that the active material and the electron conductive oxide powder are physically mixed, or the electron conductive oxide is vapor-deposited on the surface of the active material by a PVD method or a CVD method. However, in the case of the particles made into the secondary particle, only the surface of the secondary particle can be coated by the vapor deposition, and the primary particles positioned inside the secondary particle cannot be coated. Therefore, the electron conductivity inside the secondary particle cannot be enhanced with the configurations of PTLs 2 and 3.

An objective of the present invention is to provide a lithium ion secondary battery positive electrode, a lithium ion secondary battery, a vehicle mounting the same, and an electric power storage system, which improve the electron conductivity even inside an active material formed into a secondary particle.

### Solution to Problem

A lithium ion secondary battery positive electrode including:

a positive electrode active material expressed by

xLi₂MO₃-(1-x)LiM′O₂

(where x is 0<x<1, M is at least one type selected from Mn, Ti, and Zr, and M′ is at least one type selected from Ni, Co, Mn, Fe, Ti, Zr, Al, Mg, Cr, and V),

the positive electrode active material forming a secondary particle in which a plurality of primary particles without grain boundary are aggregated/bonded,

wherein not only the primary particles positioned on a surface of the secondary particle of the positive electrode active material, but also the primary particles positioned inside the secondary particle are coated with an electron conductive oxide having higher electron conductivity than the positive electrode active material.

### Advantageous Effects of Invention

According to the present invention, a lithium ion secondary battery positive electrode, a lithium ion secondary battery, a vehicle mounting the same, and an electric power storage system that enhances the electron conductivity from a surface to an inside of the active material secondary particle and decreases electrode resistance.

### BRIEF DESCRIPTION OF DRAWINGS

FIG. 1 is a schematic diagram of a positive electrode of an example.

FIG. 2 is a schematic diagram of a positive electrode of a comparative example.

FIG. 3 is a schematic diagram of a positive electrode of a comparative example.

FIG. 4 is a schematic diagram of a cylindrical battery (lithium ion secondary battery).

FIG. 5 is a diagram illustrating discharge capacities of examples 1 to 4 and a comparative example.

FIG. 6 is a schematic plan view of a driving system of an electric automobile (vehicle) 30.

FIG. 7 is a schematic diagram of a power generation system S using a battery module.

### DESCRIPTION OF EMBODIMENTS

Hereinafter, embodiments of the present invention will be described with reference to the appended drawings.

Embodiments of the present invention are exemplarily described, and the present invention is not limited to the exemplarily-described embodiments below.

A lithium ion secondary battery including a positive electrode of the present invention can employ a configuration similar to a conventional basic configuration. For example, the lithium ion secondary battery can include a positive electrode, a negative electrode, and a separator sandwiched by the positive and the negative electrodes and impregnated in an organic electrolyte. Note that the separator separates the positive electrode and the negative electrode and prevents short circuit, and has ion conductivity that allows the lithium ions (Li⁺) to pass through. Further, the positive electrode is configured from a positive electrode active material, an electron conducting material, a binder, a current collector, and the like.

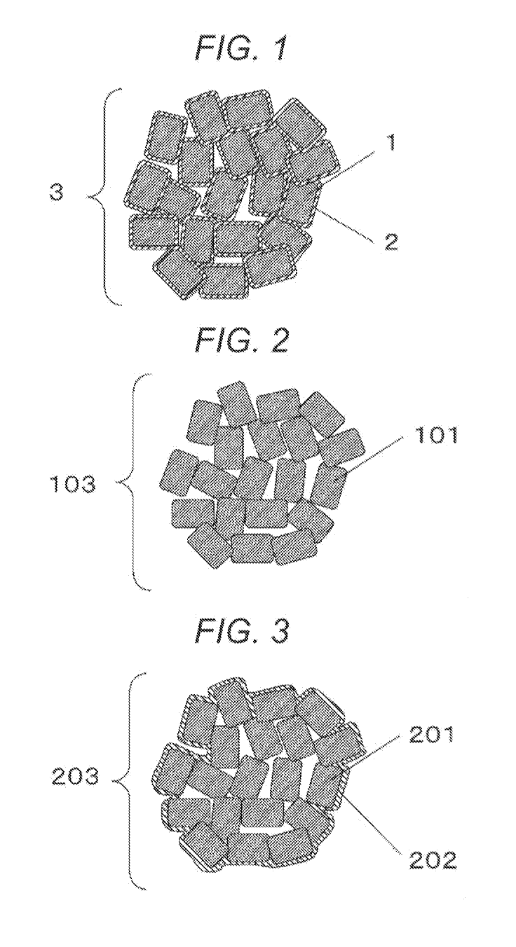

FIG. 1 is a schematic diagram of a cross section of a solid solution positive electrode active material secondary particle 3 according to an embodiment of the present invention, FIG. 2 is a schematic diagram of a cross section of a positive electrode active material secondary particle 103 of a normal comparative example that does not include electron conductive oxide coating, and FIG. 3 is a schematic diagram of a cross section of a positive electrode active material secondary particle 203 of a comparative example, in which an electron conductive oxide is coated by physical mixture or vapor deposition of electron conductive oxide powder.

As illustrated in FIG. 2, conventionally, in a solid solution positive electrode active material, a plurality of solid solution positive electrode active material primary particles 101 are aggregated/bonded to form a solid solution positive electrode active material secondary particle 103, in order to realize both of a small particle diameter and easy handling. Further, as illustrated in FIG. 3, when a solid solution positive electrode active material secondary particle 203 is coated with an electron conductive oxide by physical mixture or vapor deposition of conductive oxide power, instead of solid solution positive electrode active material primary particles 201, only the primary particles on the surface of the secondary particle are coated with an electron conductive oxide 202.

In contrast, as illustrated in FIG. 1, in a solid solution positive electrode active material (Li₂MO₃—LiM′O₂ solid solution) secondary particle 3 of the present invention, not only the primary particles positioned on the surface of the secondary particle but also solid solution positive electrode active material primary particles 1 positioned inside the secondary particle are coated with an electron conductive oxide 2, whereby the electron conductivity is provided and resistance of the positive electrode is decreased. Note that, in the solid solution positive electrode active material Li₂MO₃—LiM′O₂ solid solution, M is one or more types of chemical elements selected from Mn, Ti, and Zr, and M′ is one or more types of chemical elements selected from Ni, Co, Mn, Fe, Ti, Zr, Al, Mg, Cr, and V.

It is not desirable that a ratio of the electron conductive oxide to the solid solution positive electrode active material is increased because the capacity density as the positive electrode is decreased and Li ion diffusion is impeded. Therefore, a weight ratio of the electron conductive oxide to the solid solution positive electrode active material is favorably 10% or less, and is more favorably 3% or less. Further, to provide sufficient electron conductivity with a less weight, the electron conductivity of the electron conductive oxide is favorably 1 S/cm or more. Examples of a material that satisfies the electron conductivity includes ITO (In₂O₃—SnO₂), AZO (ZnO—Al₂O₃), SnO₂, TiO₂, and the like. Further, it is not necessary to completely coat the surfaces of the primary particles of the solid solution positive electrode active material if a conductive network is obtained in the electron conductive oxide.

### Example 1

Hereinafter, an example 1 will be described as one form for describing the present invention in detail.

### (Production of Solid Solution Positive Electrode Active Material)

As a material, a salt of a metal element indicated by M and M′ of the Li₂MO₃—LiM′O₂ (M is one or more types of chemical elements selected from Mn, Ti, and Zr, and M′ is one or more types of chemical elements selected from Ni, Co, Mn, Fe, Ti, Zr, Al, Mg, Cr, and V) and having high water solubility (for example, sulfate or nitrate) can be used. As a specific example, weights of nickel sulfate hexahydrate (NiSO₄.6H₂O), cobalt sulfate heptahydrate (CoSO₄.7H₂O), and manganese sulfate pentahydrate (MnSO₄.5H₂O) were measured to satisfy Ni:Co:Mn=1:1:4 (molar ratio) and were dissolved in pure water, and a mixed solution was adjusted.

A part of the sulfate mixed solution was heated to 50° C., and ammonia water was dropped as a complexing agent while the solution was stirred until pH=7.0 is achieved. Further, the sulfate mixed solution and a Na₂CO₃ solution were dropped, and composite carbonates of Ni, Co, and Mn were co-precipitated. At this time, the ammonia water was dropped to maintain pH=7.0. The co-precipitated composite carbonates were sucked and filtered, washed with water, and dried at 120° C. The obtained composite carbonates were put in an alumina container and calcined at 500° C., and a composite oxide was obtained. As a lithium salt added to the obtained composite oxide, LiOH.H₂O or Li₂CO₃ can be used. To be specific, the weight of LiOH.H₂O was measured such that Li/(Ni+Co+Mn)=1.5 (molar ratio) is satisfied, LiOH.H₂O was added to the composite oxide, and the composite oxide with LiOH.H₂O was mixed by a ball mill. Following that, the mixture was put in an alumina container, pre-calcined at 500° C., and mixed by a ball mill again. Following that, the mixture was calcined at 900° C., and powder of the solid solution positive electrode active material was obtained. The obtained solid solution positive electrode active material formed spherical secondary particles having a diameter of 5 μm in which the primary particles having a diameter of 100 nm were aggregated/bounded.

### (Coating of Electron Conductive Oxide)

The solid solution positive electrode active material powder was put in a solution obtained such that a 2-ethylhexanoic acid of In and Sn of In:Sn=95:5 was diluted with n-butyl acetate, and the solution was diffused into an inside of the solid solution secondary particle by ultrasonic vibration. Following that, the powder was collected by suction filtration and subjected to thermal treatment at 600° C., and an ITO film was formed on a surface of the solid solution positive electrode active material.

### (Production of Positive Electrode)

The coated solid solution positive electrode active material, a carbon-based electron conducting material, and a binder dissolved in N-Methyl-2-pyrrolidinone (NMP) in advance were mixed at a proportion of 85:10:5 in percent by mass (%), and uniformly mixed slurry was applied on a current collector made of an aluminum foil having a thickness of 20 μm. Following that, the slurry on the current collector was dried at 120° C. and subjected to compression molding by a press such that the electrode density becomes 2.3 g/cm³.

### (Production of Lithium Ion Secondary Battery)

Next, production of a lithium ion secondary battery will be described.

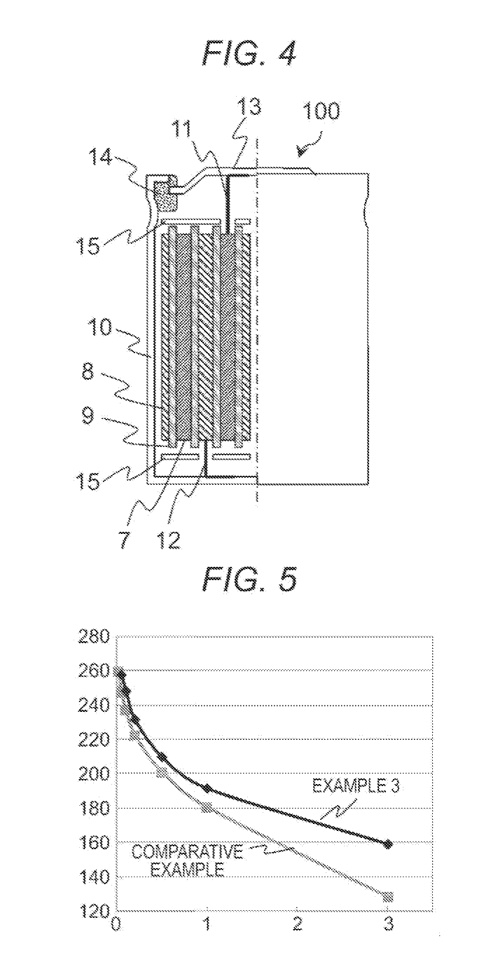

A positive electrode 7 of the present invention can be applied to a lithium ion secondary battery formed into a cylindrical shape, a flat shape, a square shape, a coin shape, a button shape, or a sheet shape. As a representative example, a structure of a cylindrical battery (lithium ion secondary battery) 100 is illustrated by a half cross sectional view of FIG. 4.

A negative electrode 8 is more favorable as the discharge potential is lower, and as the negative electrode 8, various materials, such as a lithium metal, carbon having a low discharge potential, Si or Sn having a high weight ratio capacity, lithium titanate (Li₄Ti₅O₁₂) having high safety, can be used.

A lithium ion secondary battery was produced using the positive electrode 7, the negative electrode 8, a separator 9, and an electrolyte solution (electrolyte).

Here, a lithium metal was used as the negative electrode 8, a porous polyethylene (PP) separator having ion conductivity and insulation properties was used as the separator. As the electrolyte solution (electrolyte), a solution made such that ethylene carbonate (EC), ethyl methyl carbonate (EMC), and dimethyl carbonate (DMC), which are non-aqueous organic solvents, were mixed with a volume proportion 1:2:2, and 1 mol/L of lithium hexafluorophosphate (LiPF₆) was dissolved in the mixture was used.

The cylindrical battery (lithium ion secondary battery) 100 is produced as follows.

The positive electrode 7 and the negative electrode 8 are wound in a spiral manner through the porous polyethylene (PP) separator 9, and are housed inside a cylindrical battery can 10. The positive electrode 7 is electrically connected with a sealing lid 13 by a positive electrode lead 11. The negative electrode 8 is electrically connected with a bottom portion of the battery can 10 by a negative electrode lead 12.

Further, the negative electrode-side battery can 10 and the positive electrode-side sealing lid 13 are electrically insulated by a packing 14 that is an insulating material and a sealing material, and an inside of the battery is sealed. Note that an insulating plate 15 is inserted for insulation between the positive electrode 7 and the negative electrode-side battery can 10, and the insulating plate 15 is inserted for insulation between the negative electrode 8 and the positive electrode-side sealing lid 13.

Finally, an electrolyte solution (electrolyte) is poured through a liquid injection port (not illustrated) provided in the battery can 10, and the cylindrical battery (lithium ion secondary battery) 100 was obtained.

### Example 2

An example 2 is similar to the example 1 except that a positive electrode active material was coated with SnO₂ in a process of coating of an electron conductive oxide.

### Example 3

An example 3 is similar to the example 1 except that a positive electrode active material was coated with AZO of Zn:Al=98:2 in a process of coating of an electron conductive oxide.

### Example 4

An example 4 is similar to the example 1 except that a positive electrode active material was coated with a TiO₂ film in a process of coating an electron conductive oxide.

### Comparative Example

A comparative example is similar to the example 1 except that a positive electrode active material was not coated with an electron conductive oxide.

### (Powder Resistance Measurement)

Powder resistance of the positive electrode active materials of the examples 1 to 4 and the comparative example was measured. Measurement results are shown in Table 1. The powder resistance of the examples was decreased compared with the comparative example.

TABLE 1

| | Powder Resistance |
|---|---|
| Material | [Ω · cm] |
| Example 1 | 2.0 × 10⁶ |
| Example 2 | 3.4 × 10⁶ |
| Example 3 | 2.6 × 10⁶ |
| Example 4 | 5.1 × 10⁶ |
| Comparative | 1.1 × 10⁷ |
| Example | |

### (Evaluation of Lithium Ion Secondary Battery)

Lithium ion secondary batteries using the positive electrodes of the examples 1 to 4 and the comparative example were charged to 4.6 V by constant current/constant potential charge of 0.05 C, and were then discharged to 2.5 V by a constant current from 0.05 to 3 C, and the discharge capacities were measured. Here, a “charge/discharge rate 1 C” means completion of 100% charge in one hour when a battery is charged from a state where the battery is fully discharged, and completion of 100% discharge in one hour when the battery is discharged from a state where the battery is fully charged. That is, the speed of charge or discharge is 100% per hour. Therefore, 0.05 C means the speed of charge or discharge is 5% per hour.

The discharge capacities from 0.05 to 3 C of the examples 1 to 4 and the comparative example are illustrated in FIG. 5.

The examples show higher capacities in a higher rate than the comparative example. From this, it is found that the examples can decrease the electrode resistance compared with the comparative example.

### Example 5

A battery module using one or more lithium ion secondary batteries including a positive electrode 7 of the present invention illustrated in the examples 1 to 4 can be applied to power sources of various vehicles, such as a hybrid railroad that travels with an engine and a motor, an electric automobile that travels with a motor using the battery as an energy source, a hybrid automobile, a plug-in hybrid automobile that can charge the battery from an outside, and a fuel battery automobile that takes the electric power out of a chemical reaction of hydrogen and oxygen.

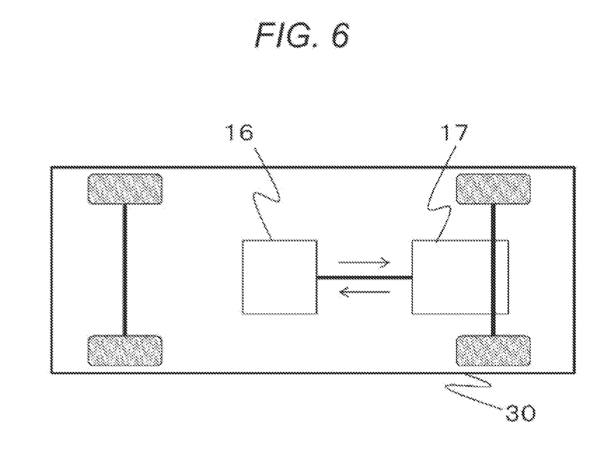

As a representative example, a schematic plan view of a driving system of an electric automobile (vehicle) 30 is illustrated in FIG. 6. From a battery module 16, the electric power is supplied to a motor 17 through a battery controller, a motor controller, and the like (not illustrated), and the electric automobile 30 is driven. Further, the electric power regenerated by the motor 17 at deceleration is stored in the battery module 16 through the battery controller.

According to the example 5, by application of the battery module 16 using one or more lithium ion secondary battery including the positive electrode 7 of the present invention, the energy density and the output density of the battery module are improved, the travel distance of the system of the electric automobile (vehicle) 30 becomes long, and an output is improved.

Note that the present invention is applicable to a forklift, a conveying vehicle in a factory or the like, an electric wheelchair, various satellites, a rocket, and a submarine, as the vehicle, other than the exemplarily illustrated vehicles, and the present invention is applicable to any vehicle without limitation as long as the vehicle includes a battery.

### Example 6

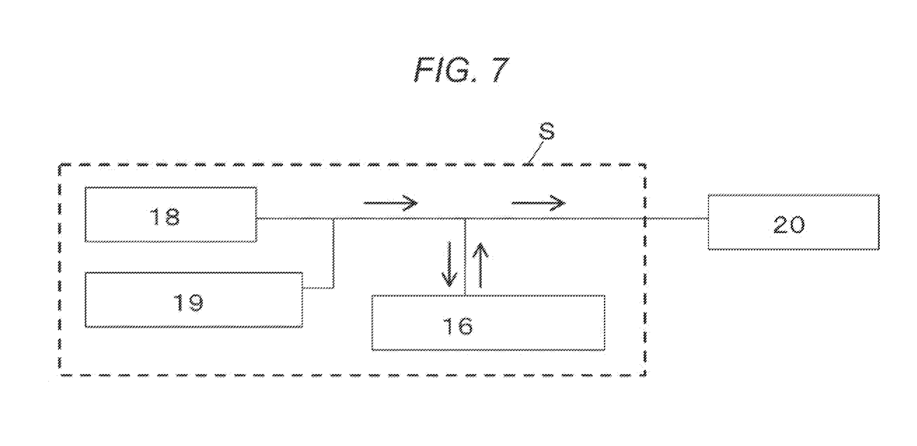

A battery module using one or more lithium ion secondary batteries including a positive electrode 7 of the present invention as illustrated in the example 5 can be applied to an electric power storage power source of a power generation system (electric power storage system) S using natural energy, such as a solar cell 18 that converts optical energy of the sun into electric power and wind power generation that generates power using wind power. An outline thereof is illustrated in FIG. 7.

The amount of power generation is unstable in the power generation using the natural energy, such as the solar cell 18 and the wind power generation device 19. Therefore, it is necessary to charge/discharge the electric power from the electric power storage power source in accordance with a load of an electric power system 20 side for the stable electric power supply.

By application of a battery module 16 using one or more lithium ion secondary batteries including a positive electrode 7 of the present invention to the electric power storage power source, a necessary capacity and output can be obtained with a small battery, and the cost of the power generation system (electric power storage system) S can be decreased.

Note that as the electric power storage system, the power generation systems using the solar cell 18 and the wind power generation device 19 are exemplarily illustrated. However, the electric power storage system is not limited to the examples, and is widely applicable to electric power storage systems using other power generation devices.

### REFERENCE SIGNS LIST

1 solid solution positive electrode active material (positive electrode active material)
2 electron conductive oxide
3 solid solution positive electrode active material secondary particle
7 positive electrode (lithium ion secondary battery positive electrode)
8 negative electrode
9 separator
10 battery can
11 positive electrode lead
12 negative electrode lead
13 sealing lid
14 packing
15 insulating plate
16 battery module (lithium ion secondary battery)
17 motor
18 solar cell
19 wind power generation device
20 electric power system
30 electric automobile (vehicle)
100 cylindrical battery (lithium ion secondary battery)
101 solid solution positive electrode active material primary particle
102 solid solution positive electrode active material secondary particle
103 positive electrode active material secondary particle (comparative example)
201 solid solution positive electrode active material primary particle
202 electron conductive oxide
203 positive electrode active material secondary particle (comparative example)
S power generation system (electric power storage system)

1. A lithium ion secondary battery positive electrode comprising:
a positive electrode active material expressed by
xLi₂MO₃-(1-x)LiM′O₂
(where x is 0<x<1, M is at least one type selected from Mn, Ti, and Zr, and M′ is at least one type selected from Ni, Co, Mn, Fe, Ti, Zr, Al, Mg, Cr, and V),
the positive electrode active material forming a secondary particle in which a plurality of primary particles without grain boundary are aggregated/bonded,
wherein not only the primary particles positioned on a surface of the secondary particle of the positive electrode active material, but also the primary particles positioned inside the secondary particle are coated with an electron conductive oxide having higher electron conductivity than the positive electrode active material.

2. The lithium ion secondary battery positive electrode according to claim 1, wherein
the conductive oxide is an oxide of at least one type selected from Sn, In, Zn, and Ti.

3. The lithium ion secondary battery positive electrode according to claim 1, wherein
the electron conductivity of the electron conductive oxide is 1 S/cm or more.

4. The lithium ion secondary battery positive electrode according to claim 1, wherein
a weight ratio of the electron conductive oxide to the positive electrode active material is 10% or less.

5. The lithium ion secondary battery positive electrode according to claim 1, wherein
powder resistance of the positive electrode active material coated with the electron conductive oxide is 1×10⁷ Ω·cm or less.

6. The lithium ion secondary battery positive electrode according to claim 1, wherein
a particle diameter of the primary particle of the positive electrode active material is 300 nm or less, and a particle diameter of the secondary particle of the positive electrode active material is 1 μm or more.

7. The lithium ion secondary battery positive electrode according to claim 1, wherein
the lithium ion secondary battery positive electrode is obtained by thermal treatment after an organometallic solution is impregnated in the secondary particle of the positive electrode active material.

8. A lithium ion secondary battery comprising the lithium ion secondary battery positive electrode according to claim 1.

9. A vehicle mounting the lithium ion secondary battery according to claim 8.

10. An electric power storage system mounting the lithium ion secondary battery according to claim 8.
